(19) United States
(12) Patent Application Publication
(10) Pub. No.: US 2013/0167410 A1
(43) Pub. Date: Jul. 4, 2013

(54) CLAM-LINK APPARATUS AND METHODS

(71) Applicant: Brian Bernard Langdon, Newcastle, WA (US)

(72) Inventor: Brian Bernard Langdon, Newcastle, WA (US)

(21) Appl. No.: 13/724,673

(22) Filed: Dec. 21, 2012

Related U.S. Application Data
(60) Provisional application No. 61/631,290, filed on Dec. 31, 2011.

(51) Int. Cl. E02F 3/58; E02F 3/47; G01B 5/02; B66C 13/04

(52) U.S. Cl. CPC E02F 3/58; B66C 13/04; E02F 3/47; G01B 5/02
USPC 37/195; 212/167; 212/270; 403/169; 73/1.81

(57) ABSTRACT

Systems and methods, etc., to improve operations where a barrier could interfere with the tag line of a clam shell dredging bucket suspended from a crane and/or the z-axis elevation of the bucket needs to be closely determined. The systems include an elongate rigid link connecting a suspended implement such as the bucket to a holding wire hanging from the crane. The elongate rigid link can further comprise at least one anti-rotation connection element located at an upper portion of the link to attach to the tag line for horizontal/rotational control, and/or comprise at least one z-axis calibration device configured to identify a z-axis elevation of the link and thereby the suspended element.

### CROSS-REFERENCE TO RELATED APPLICATIONS

The present application claims the benefit of copending U.S. Provisional Patent Application Ser. No. 61/631,290, filed Dec. 31, 2011, which application is incorporated herein by reference in its entirety.

### BACKGROUND

The current subject matter relates generally to dredging operations, for example dredging operations where an obstruction is disposed between the dredging crane and the clam shell bucket or other matter-removal device.

Dredging operations that incorporate a dredging crane, which includes a clam shell bucket, are well known and have been employed for many years. Dredging rigs that operate near barriers or structures that could interfere with the tag line are severely limited and are not well adapted for such situations.

Thus, there has gone unmet a need for improved methods for dredging crane equipment configured for managing those situations where a tag line is disposed over an obstruction that could interfere with the tag line function of controlling and restricting the rotation of the clam shell bucket. The present systems and methods, etc., provide solutions for one or more of these and/or other situations.

### SUMMARY

The present systems, devices and methods, etc., increase the efficiency and/or reduce the cost of dredging or other digging operations where the digging device such as a dredging bucket such as a clam shell bucket is suspended by a holding wire such as a cable, e.g., a strong, typically metal, large-diameter wire rope, or other suitable rope or cord, etc., and used to dig, dredge or excavate soil, sediment or other matter. The systems, etc., are particularly useful in operations where the bucket or device is not visible to the operator controlling the bucket, such where the bucket is underneath the surface of the water or beyond a wall or rampart obstruct the tag line from the dredge crane to a suspended implement such as the digging device, or where the tag line from the dredge crane to the suspended implement may cross such a wall, fence, etc., even if the suspended implement remains visible. This is due in part because the systems, etc., provide for careful control of the direction of the clam shell bucket—inhibiting unwanted rotation of the bucket—and/or because the systems can provide precise control and determination of the elevation (z-axis) of the clam shell bucket. Such z-axis elevation can be provided for example as an absolute elevation, or relative to the surface of the water, or relative to a remote measurement device. The systems can also provide effective approaches to keep the tag line above interfering structures.

In one aspect, the systems, etc., comprise a clam-link for connecting a clam shell bucket to cables of a dredging crane. The cables include a vertically oriented holding wire for suspending the clam-link, and a tag line for horizontal control to restrict the clam-link from uncontrolled rotation. The clam-link is one example of a vertically oriented elongate rigid support structure, i.e., a vertically oriented elongate rigid link or element between the hanging wire and a suspended implement, having an upper first end, starting at a proximal end, that is configured for attachment to a holding wire of a dredging crane, and a second lower end, ending in a distal end, that is configured for attachment to a suspended implement such as the clam shell bucket.

Additionally, the clam-link includes at least one anti-rotation connection mount disposed on a portion of the upper first end of the support structure. The anti-rotation connection mount is configured for attachment to a tag line that extends from a dredging crane. In this way, uncontrolled rotation of the clam-link and the clam shell bucket is restricted.

Thus, such systems, etc., manage situations where obstructions are located between a crane such as a dredging crane and a suspended implement hanging by a cable, i.e., a strong, typically metal, large-diameter wire rope, etc., from the crane. The suspended implement can be, for example, a digging device such as a clam shell bucket or a hook or basket. The systems, etc., are effected in part by employing methods that insure that the clam shell bucket is responsive to operator controls. The systems, etc., stabilize a clam shell bucket from uncontrolled rotation during the dredging operation and/or maintain a consistent dredging depth, which in turn allows an operator to know exactly where the clam shell bucket is at all times during the dredging operation. Such determination of the relative elevation (z-axis) of the clam shell bucket (or other suspended digging device) can be particularly advantageous because the user, such as a crane operator, can then accurately and precisely dig to a desired depth but not beyond.

Typically, the anti-rotation connection mount includes two arms (members) that extend substantially horizontally outward from the support structure with the tag line being connected to one of the arms, at a point spaced from the support structure. In order to control the rotational position of the clam shell bucket, the two arms generally lie in the same plane, and extend outwardly from the support structure to form a right angle. Accordingly the clam shell bucket can be rotated in 90 degree increments depending on the arm that is selected for the tag line connection. In some embodiments, a chain spans the distance between the two arms, which can be set at any desired angle relative to each other, the chain thereby providing for variable tagline attachment points and thus variable adjustment of the orientation of the bucket. In further embodiments, a rotationally adjustable anti-rotation connection element can be disposed between or along the clam-link and the arm to adjust the relative angle of the arm to the clam-link.

In another embodiment, the clam-link includes a pressure transducer or other water-depth measurement device that is mounted on the support structure. In this way, as the clam-link and clam shell bucket is lowered into the water, the change in water pressures at varying depths can be communicated to positioning software which can convert the same to indicate depth in feet or meters, of the clam shell bucket. In further embodiments, the clam-link can comprise a platform that can hold an electronics package for electronic depth monitoring.

Thus, in some aspects, the clam-links 20 herein can be configured solely for z-axis measurement and determination, without a rotation-limiting tag-line attachment element.

Due to one or more of their advantages, the devices, methods, etc., herein, can extend the life of holding wire, for example because wire can be shortened easily without needing to re-paint marks on the holding wire. In addition the digging marks (calibration marks) can be more visible on the clam-link than when they are on the holding wire. The higher tagline attachment point can give a better horizontal force component and can prevent the tagline from “burning or sawing” on an obstruction such as a dock or coffer cell that is between the bucket and the crane.

In one aspect, the present systems, devices and methods, etc., provide a clam-link for connecting a clam shell bucket to cables of a dredging crane, the cables including a vertically oriented holding wire for suspending the clam-link, and a tag line for horizontal control to restrict the clam-link from rotation. The clam-link further comprises a vertically oriented rigid support structure having an upper first end configured for attachment to a holding wire of a dredging crane, and a second lower end configured for attachment to a clam shell bucket; at least one anti-rotation connection mount disposed on a portion of the upper first end of the support structure; and wherein the anti-rotation connection mount can be configured for attachment to a tag line extending from a dredging crane to restrict rotation of the clam-link and the clam shell bucket.

The anti-rotation connection mount can include at least one arm (member) that extends outward from the support structure and can include a second arm disposed outward from the support structure wherein the angle between the anti-rotation arms can be substantially 90 degrees.

In another aspect, the present systems, devices and methods, etc., provide an elongate rigid link configured to connect a suspended implement to a vertically oriented holding wire hanging from a crane and to a tag line for horizontal control to restrict the elongate rigid link from rotation. The elongate rigid link can comprise an elongate rigid element having an upper first end configured to operably attach to the holding wire suspended from the crane and a second lower end configured to operably attach to the suspended implement; and, at least one anti-rotation connection element located at an upper portion of the elongated rigid link and configured to operably attach to the tag line.

The crane can be a dredging crane, the elongate rigid link can be a clam-link and the suspended element can be a digging device, which can be a clam shell bucket or any other suitable digger.

The anti-rotation connection element can comprise at least one arm extending outwardly from the elongate rigid element and configured to connect to a tagline and can further comprise a second arm extending outwardly from the elongate rigid element at substantially a 90° angle relative to the first arm. The anti-rotation connection element further can comprise at least one further arm extending outwardly from the elongate rigid element at an angle relative to the first arm, wherein a chain or other structure providing multiple tagline attachment points extends between the one arm and the second arm to provide multiple attachment points for the tagline. The elongate rigid link further can comprise at least one rotationally adjustable element controlling an angle of the clam-link relative to the anti-rotation connection element and to thereby variably set an angle of the digging device relative to the crane.

The elongate rigid link further can comprise at least measurement device or system, such as a set of calibrated marks disposed along a length of the elongate rigid link wherein the set of calibrated marks indicates a distance from a given calibrated mark to a lower end of the elongate rigid link. The set of calibrated marks can be located on a movable substrate that can be movable along a length of the elongate rigid link to thereby adjust a z-axis location of the set of calibrated marks relative to the elongate rigid link. The elongate rigid link further can comprise at least one RTK GPS unit configured to indicate the elevation of the elongate rigid link.

The elongate rigid link can be a hollow tube, and the hollow tube can contain at least one float within the tube, the float configured to indicate a water level within the tube and the claim link further can comprise at least one measurement device located above the float configured to measure a distance from the measurement device to the float. The elongate rigid link further can comprise at least one target configured to reflect a beam from a remotely located tracking device; the target can be a prism target. The elongate rigid link further can also comprise at least one pressure transducer configured to indicate a depth of a distal end of the elongate rigid link below a water surface.

In another aspect, the present systems, devices and methods, etc., provide a crane comprising elongate rigid link or clam-link as discussed herein extending from a distal end of a cable such as a hanging wire hanging from a boom of the crane. The crane can be a dredging crane and the clam-link can extend between the distal end of the cable and a dredging bucket, which can be a clam shell bucket.

In still another aspect, the present systems, devices and methods, etc., provide an elongated rigid link configured to connect a suspended implement to a vertically oriented holding wire hanging from a crane. The elongated rigid link comprises an elongate rigid element having an upper first end configured to operably attach to the holding wire, a second lower end configured to operably attach to the suspended implement, and at least one z-axis calibration device configured to identify a z-axis elevation of the elongated rigid link and thereby the suspended element. The z-axis calibration device can be any suitable device or system such as those discussed herein.

In still a further aspect, the present systems, devices and methods, etc., provide methods of operating a crane such as a dredging crane. Such methods can comprise:
a) providing a crane can comprise a hanging wire having elongate rigid link or clam-link as discussed herein; and,
b) raising or lowering a suspended implement such as a clam-shell bucket suspended from a lower end of the elongate rigid link or clam-link. The methods can further comprise manipulating the suspended implement via a tag line, operating line or other connection to the crane.

The methods further can comprise restricting rotation of the clam-link by attaching a tag line to the anti-rotation connection mount, selectively rotating the clam-link by 90° or other desired angle by detaching the tag line from a first anti-rotation connection mount and connecting it to a second anti-rotation connection mount disposed 90° from the first anti-rotation connection mount.

The methods further can comprise determining a z-axis elevation of the elongate rigid link or clam-link during the raising or lowering of the suspended implement such as a clam-shell bucket.

Alternative methods of operating a crane can comprise:
a) providing a crane can comprise a hanging wire having an elongate rigid link as discussed herein; and,
b) raising or lowering a suspended implement suspended from a distal end of the elongate rigid link.

The methods further can comprise restricting rotation of the elongate rigid link by attaching a tag line to the anti-rotation connection mount. The angle of the suspended implement to the crane can be controlled by selectively rotating the elongate rigid link among multiple different angles relative to the first anti-rotation connection mount by moving the tag line among multiple different attachment points disposed on the elongate rigid link.

The methods further can comprise determining a z-axis elevation of the elongate rigid link during the raising or lowering of the clam-shell bucket. Devices and systems useful for such z-axis determination can be those discussed herein. The crane can be a dredging crane, the elongate rigid link can be a clam-link and the suspended element can be a digging device. The digging device can be a clam shell bucket and method further can comprise opening and closing the clam shell bucket.

In still a further aspect, the present systems, devices and methods, etc., provide methods of using an elongate rigid link. Such methods can comprise:
a) providing an elongate rigid link as discussed herein; and,
b) connecting a distal end of the elongate rigid link to suspend a suspended implement from the elongate rigid link.

The elongate rigid link or clam-link further can be raised or lowered, for example by a hanging wire from a crane it's suspended from, thereby raising or lowering the suspended implement suspended from a distal end of the elongate rigid link.

The methods further can comprise restricting rotation of the elongate rigid link by attaching a tag line to the anti-rotation connection mount, and/or determining a z-axis elevation of the elongate rigid link during the raising or lowering of the clam-shell bucket and/or during any other use of the elongate rigid link or clam-link such as use of the suspended implement even if the elongate rigid link or clam-link is not intentionally raised or lowered during such use.

Further methods can comprise determining a z-axis elevation of an elongate rigid link. Such methods can comprise:
a) providing the elongate rigid link as discussed herein; and,
b) reading the z-axis elevation of the at least one z-axis calibration device of the elongated rigid link and thereby determining the z-axis elevation of the elongate rigid link.

The elongated rigid link can have a suspended implement suspended from a lower end.

In still another aspect, the systems, methods, etc., herein can comprise an assembly comprising a crane; a vertically oriented holding wire hanging from the crane; a suspended implement hanging from the holding wire; and an elongated rigid link disposed between a distal end of the holding wire and a proximal end of the suspended implement, the elongated rigid link can comprise an elongate rigid element having an upper first end configured to operably attach to the holding wire and a second lower end configured to operably attach to the suspended implement.

The assembly further can comprise at least one z-axis calibration device configured to identify a z-axis elevation of the elongated rigid link and thereby the suspended element. The crane can be a dredging crane, the elongated rigid link can be a clam-link and the suspended element can be a digging device such as a clam shell bucket.

The assembly further can comprise at least one anti-rotation connection element located at an upper portion of the elongated rigid link and configured to operably attach to the tag line.

These and other aspects, features and embodiments are set forth within this application, including the following Detailed Description and attached drawings. Unless expressly stated otherwise, all embodiments, aspects, features, etc., can be mixed and matched, combined and permuted in any desired manner. In addition, various references are set forth herein, including in the Cross-Reference To Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIG. 1 is a perspective view illustrating two spaced apart dredging cranes, each disposed behind a barrier located between the crane and an area to be dredged, wherein a first crane includes a clam-link extending down from the holding wire thereof connected to a clam shell bucket, and a second dredging crane having a typical set-up where the holding wire is connected directly to the a clam shell bucket.

FIG. 2 is a perspective view of a clam-link.

FIG. 3 is a partial perspective view of the upper first end of a clam-link illustrating the connection to a holding wire, and to a tag line.

FIG. 3A is a partial perspective view of a further embodiment of an upper first end of a clam-link illustrating the connection to a holding wire, and to a tag line.

FIG. 4 is a perspective view of a clam-link connected to a clam shell bucket.

FIG. 5 is a partial exploded view of the connection between a clam-link and a clam shell bucket.

FIG. 6 is a partial perspective view illustrating the connection between a clam-link and a clam shell bucket.

FIG. 7 is a perspective view of a clam-link connected to a hook.

FIG. 8 is a perspective view of an alternative connection structure for a vertically oriented elongate rigid support structure connected to a suspended element.

FIG. 9 is a partial perspective view of a further embodiment of an upper first end of a clam-link.

### DETAILED DESCRIPTION

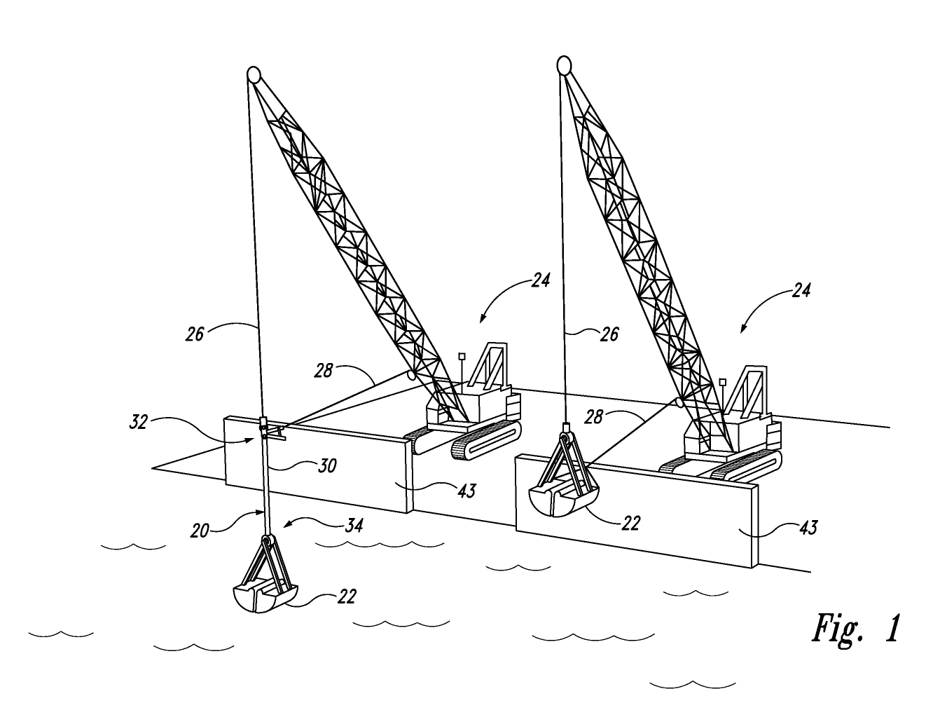

FIGS. 1 through 8 show embodiments of the systems, etc., herein, with particular examples for clam shell buckets and dredging cranes. Many of the embodiments can apply to any desired crane with a hanging suspended implement. Thus, for example, the Figures show a clam-link 20 that is employed for connecting a clam shell bucket 22 to cables of a dredging crane 24. The cables include a vertically oriented holding wire 26 for suspending the clam-link 20, and a tag line 28 for horizontal control to restrict the clam-link 20 from rotation. Specifically, the clam-link 20 comprises a vertically oriented elongate rigid support structure 30 such as an elongate rigid link. The elongate rigid support structure 30 has an upper first end 32 configured for attachment to a holding wire 26 of a dredging crane 24, and a second lower end 34 configured for attachment to a clam shell bucket 22. Additionally, the clam-link 20 includes at least one anti-rotation connection mount 36 disposed on a portion of the upper first end 32 of the support structure 30. The anti-rotation connection mount 36 is configured for attachment to a tag line 28 that extends from a dredging crane 24. In this way, rotation of the clam-link 20 and the clam shell bucket 22 is restricted.

Typically, the anti-rotation connection mount 36 includes two arms 38-40 that extend substantially horizontally outward from the support structure 30 with the tag line 28 being connected to one of the arms, at a point spaced from the support structure 30. In order to control and restrict the rotational position of the clam shell bucket, the two arms 38-40 generally lie in the same plane, and extend outward from the support structure 30 to form a right angle. Accordingly the clam shell bucket 22 can be rotated in 90 degree increments depending on the particular arm that is selected for the tag line 28 connection.

Additionally, as will be discussed more fully below, one embodiment of a clam-link 20 includes a pressure transducer 42 or other z-axis determination device that is mounted on the clam-link 20, for example on the support structure 30 of the clam-link 20. In this way, as the clam-link 20 and clam shell bucket 22 are lowered into the water, the change in water pressures at varying depths can be communicated to the positioning software which can convert the same to indicate depth in feet or meters, of the clam shell bucket 22.

Directing attention to FIG. 1, spaced apart dredging cranes 24 are shown disposed behind a barrier 43 to illustrate how a dredging crane that employs the clam-link 20 can be lowered further without interference of the barrier 43. Accordingly, a clam-link arrangement allows the operator of a dredging crane 24 much more flexibility in marine situations that may include docks, wharfs, piers etc. Similarly, another common situation is operating a clam shell bucket 22 within a cofferdam (not illustrated) which presents much the same problem.

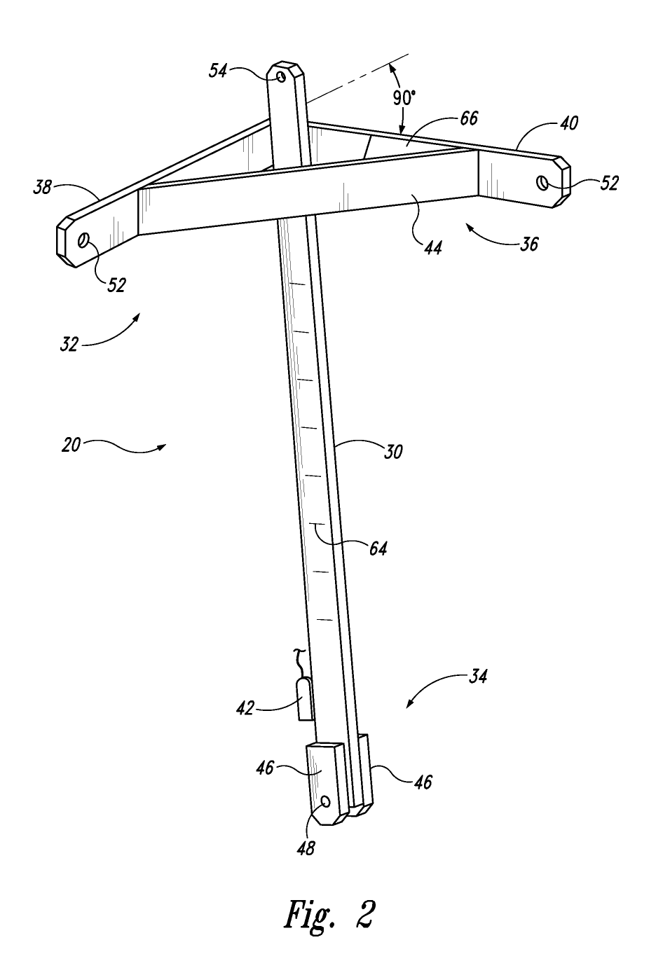

Considering now in more detail the components from which a clam-link 20 can be constructed, the most common material employed in the construction of a clam-link is steel. Any suitable material can be used, however, such as stainless steel, other metals, carbon fiber, or any other strong, rigid material. For example, FIG. 2 illustrates a vertically oriented support structure 30 incorporating rectangular steel flat bar material. Any suitable shape can be used, however, such as wide flange or tubing (for example tubing or solids having a circular, hexagonal, H-beam or I-beam, or square cross-section).

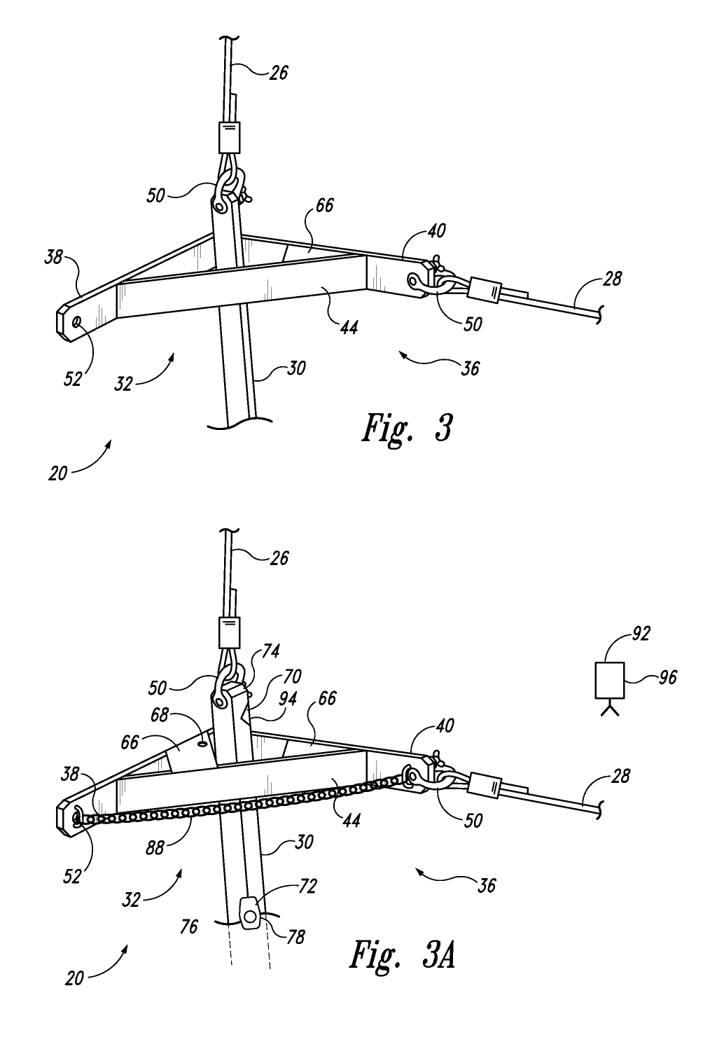

Similarly, an anti-rotation connection mount 36 includes two arms 38-40 attached to the upper first end 32, each arm utilizing steel flat bar material, or any suitable shape, and are connected to the support structure 30 so that they extend 90 degrees relative to each other. Additionally, to improve stiffness and rigidity, an optional brace 44 extends from one arm 38 to the other arm 40, and is also constructed from flat bar material. In this way, an operator can maintain a clam shell bucket 22 from rotation by a tag line 28 that applies a resisting moment. The tag line 28 is attached by a shackle 50 (FIG. 3) that is disposed through a bore 52. Similarly, a shackle 50 or open wedge socket is used to connect the holding wire 26 to the clam-link 20.

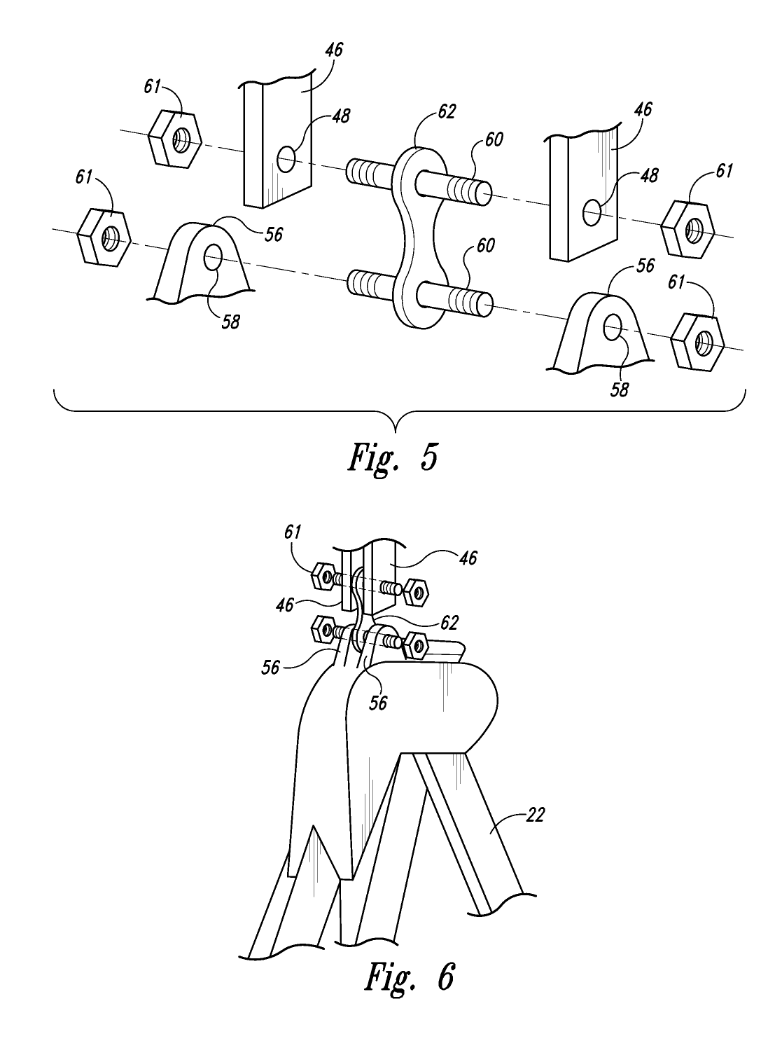

At the lower end 34, two plates 46 are attached to the support structure 30. The plates include a bore 48 for a bolted attachment to a clam shell bucket 22 (see FIGS. 5 & 6). It should be noted that welding is the most common method for fitting and attaching the various members together, however other methods of joining the members could be employed including bolt type fasteners.

Turning now to FIG. 3, the connection of the tag line 28 and the holding wire 26 are illustrated using shackles through bores 52 for the tag line 28 and through bore 54 disposed at the upper first end 32; any suitable connection such as wedge sockets can be used as desired.

In FIG. 3A, a chain 88 is disposed between the two tagline arms 38, 40. The chain 88 provides multiple attachment points for the tagline so that virtually any desired angle of the claim shell bucket relative to the crane can be achieved—without the need to move the crane. Also in FIG. 3A, the clam-link 20 is a hollow tube 74, which like solid versions of the clam-link 20 can be round or square or any other desired shape. Use of a hollow tube elongate member permits a user to determine a true water level in the environment of use of the clam-link because water within the tube is not affected by transient waves or froth or the like. Thus, a float 72 can be disposed within the tube to indicate the internal water line 76 of the water, regardless of the potentially rapidly changing level of the external water line 78. The vertical position of this float could be determined using a laser 108. The clam-link 20 can also comprise a shelf 66, which can hold any desired elevation-indication devices such as An RTK GPS 68 unit, and the clam-link 20 can comprise a beam target 70 for a remotely located tracking device 92 such as a prism target 94 for a robotic total station 96.

Additional exemplary z-axis measurement devices and systems include ultra sonic and sonic devices. These systems can comprise using a transducer at the top of a tube-shaped claim-link to send and receive sound waves through the air to measure the distance to the water level within the tube. Ultra sonic and sonic equipment is available commercially. Another approach is an air bubbler system, where a tube with air pumping through it is place at a known location within or along a claim-link. The pressure in the air-bubbler tube is a function of the back pressure provided by the surrounding water. This pressure is measured and converted to depth of submergence. Still another approach is an indirect air pressure. Wherein the top end of a tube-shaped claim-link is sealed and then the air pressure inside the tube is compressed by the rising water. This is an indirect measure and like sonic-related methods may be impacted by the temperature of the air or other ambient conditions.

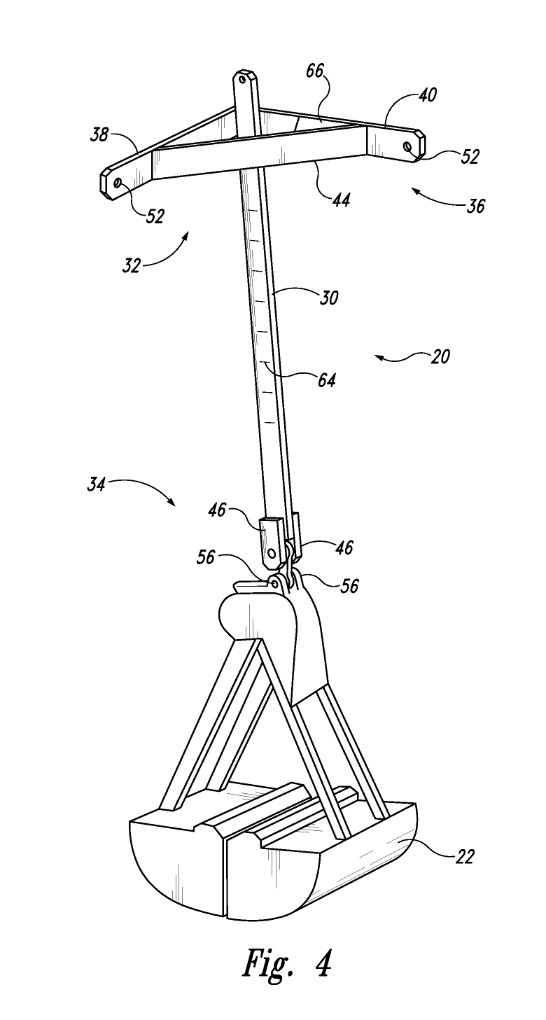

An exemplary attachment of the clam shell bucket 22 to the clam-link 20 is illustrated in FIGS. 4, 5 & 6. Briefly, FIG. 6 shows a clam shell bucket 22 having spaced apart lugs 56, each with a bore 58 arranged to receive a bolt 60 with nut(s) 61 In this way a link 62 can be connected to the clam shell bucket 22, and to the lower end 34 of the support structure 30. Similarly, a bolt 60 is used to connect the link 62 to the lower end 34, through bores 48.

One important part of dredging is controlling the elevation of the clam shell bucket 22 relative to a project datum elevation. A typical dredging specification will require dredging to a required grade. Typically, this is done by marking the holding wire 26 with calibrated marks that are referenced to the height of the clam shell bucket. However, problems with this arrangement include operator confusion with the marks, marks that are lost when the holding wire is changed, and marks that wear off with use. Marks 64 can be applied to a clam-link 20 which eliminates the above noted problems.

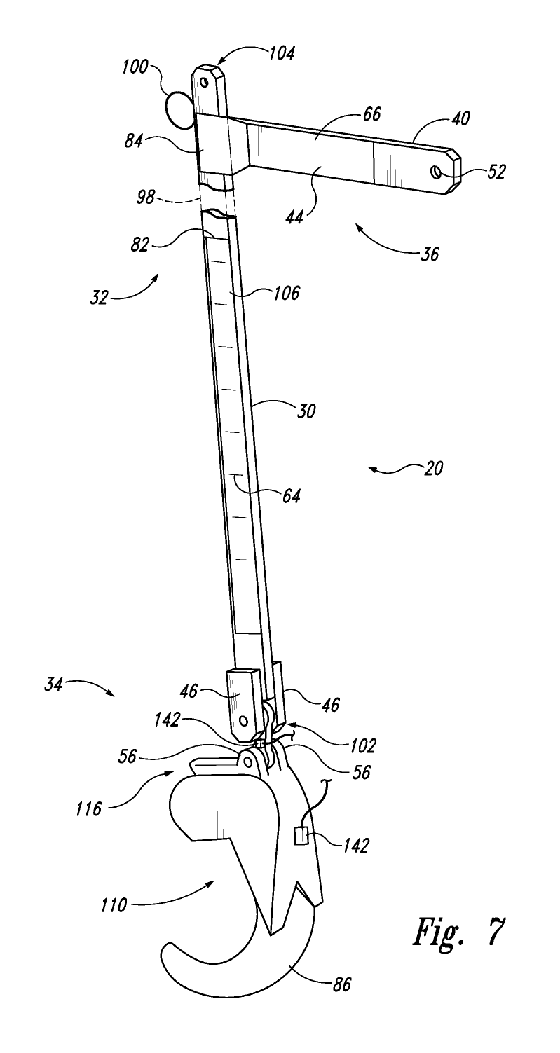

FIG. 7 depicts a partial perspective view of a clam-link 20 connected to a hook 86 and otherwise illustrating various embodiments of the systems, methods, etc., herein. For example, in FIG. 7, the clam-link 20 comprises a proximal end 104 and a distal end 102. The calibrated marks 64 are located on a movable substrate 82, such as a board 106 or length of metal, which permits the distance between the distal end 102 and proximal end 104 of the clam-link 20 to be controllably, measurably varied as needed so that the clam-link 20 can be used with different bucket heights or attachments without significant difficulty. Additionally, extension pieces 98 (shown schematically in dotted line) can be employed to adjust the length of the clam-link to fit with varying depths of water. Such extensions can be accomplished, for example, by linking multiple clam-links end-to-end, either via rigid or flexible links depending on the purposes of a particular job, or via telescoping clam-links.

FIG. 7 also shows embodiments where one or more elements of the z-axis measurement devices may be located in positions operably connected to clam-link 20 but not specifically on clam-link 20. For example, pressure transducers 142 can be disposed on the linkage 116 or suspended implement 110 operably connected to clam-link 20, in addition to or instead of being located directly on the clam-link 20 as shown in FIG. 2.

The angle of the tagline-attachment arm 40 relative to the clam-link 20 in FIG. 7 is controlled by rotationally adjustable anti-rotation connection element 84. This provides for variable tagline attachment—i.e., it variably rotates the angle of bucket relative to clam-link 20 and therefore the crane.

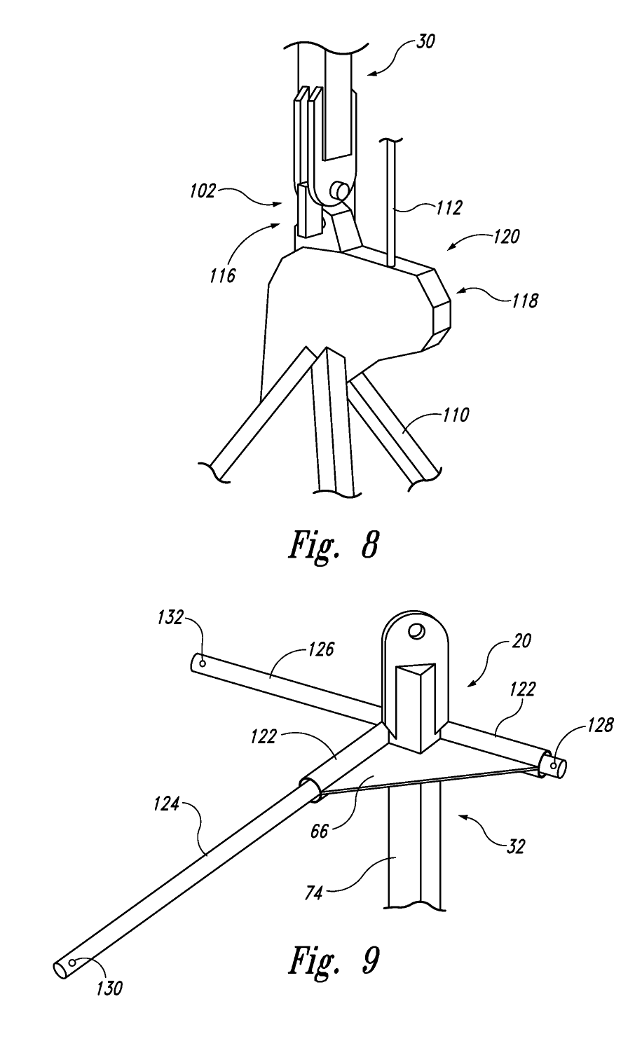

FIG. 8 is a perspective view of an exemplary alternative connection assembly 120 for a vertically oriented elongate rigid support structure 30 connected at its distal end 102 to a suspended element 110. The connection assembly 120 is connected via a linkage 116 to the distal end 102 to a suspended implement, in this case the top 118 of the suspended implement 110. The top 118 and suspended implement 110 are manipulated by auxiliary line 112 relative to the vertically oriented elongate rigid support structure 30.

FIG. 9 is a partial perspective view of a further embodiment of an upper first end 32 of a clam-link 20. The clam-link 20 is a hollow tube 74, which like solid versions of the clam-link 20 can be round or square or any other desired shape. The clam-link 20 comprises a shelf 66 disposed between two hollow pipes 122 containing corresponding bars 124, 126 that form an anti-rotation connection mount 36. The bars 124, 126 comprise tag-line attachment points 128, 130, 132 (a further tag-line attachment point on bar 124 is inside hollow pipe 122 and therefore not visible in the Figure). Bars 124, 126 selectively slide back-and-forth within the two hollow pipes 122 so that the tag-line attachment points 128, 130, 132 are moved from a first position to a second position. This configuration places the tag-line attachment points at any desired location around the clam-link 20 so that the clam-link 20, and corresponding suspended implement, can be rotated to any desired angle up to 360°. For devices that are symmetrical such as many clam shell buckets, the rotation may be selectively limited to 180° since further rotation essentially only repeats prior angles. For such configurations, only a single movable pipe 122 may be provided. Other configurations can also be provided to effect 360° rotation, such as telescoping arms, rigid X-cross arms, circular plates comprising multiple tag-line attachment points, etc. Further, a chain as shown in FIG. 3A, or other suitable device such as a circular plate, can be used to provide precise selection of the angle of rotation.

In some aspects, the clam-link 20 can be configured solely for z-axis measurement and determination, without a rotation-limiting tag-line attachment element on the clam-link itself.

Further, as noted above, some embodiments of the present systems, devices, etc., can incorporates a pressure transducer 42 disposed on the support structure 30 as illustrated in FIG. 2. Although there are many arrangements that can electronically communicate the elevation of the clam shell bucket 22 in relation to the water, one embodiment incorporates a pressure transducer 42 mounted in a tube alongside or inside the support structure 30 of the clam-link 20 as to protect it. A signal is sent from the pressure transducer 42 to an appropriate receiver and software to interpret it and provide information to the operator or other locations. The information could be, for example, numbers that change color with closeness to the target, a visual graph display or an aural signal that increases beeping frequency until a solid tone is arrived at when grade is achieved (not illustrated). Dredge positioning software employed could include WINOPS, CLAM VISION, DREDGEPACK OR EQUAL.

Alternatively, bucket elevation monitoring electronics could include a RTK GPS with wireless modem. Similarly, this would broadcast the clam-link elevation, and therefore bucket elevation, directly to the dredge positioning software.

Finally, as shown in FIG. 3A a convenient location for electronics is a triangular platform such as shelf 66 formed between the arms 38-40 at the upper end of the support structure 30.

The paragraphs herein provide definitions of some of the terms used herein. All terms used, including those specifically discussed in this section, are used in accordance with their ordinary meanings unless the context or definition clearly indicates otherwise. Also unless expressly indicated otherwise such as in some claims, the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise. The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “means” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion and figures herein.

1. A clam-link for connecting a clam shell bucket to cables of a dredging crane, the cables including a vertically oriented holding wire for suspending the clam-link, and a tag line for horizontal control to restrict the clam-link from rotation, the clam-link comprising:
a vertically oriented rigid support structure having an upper first end configured for attachment to a holding wire of a dredging crane, and a second lower end configured for attachment to a clam shell bucket;
at least one anti-rotation connection mount disposed on a portion of the upper first end of the support structure; and
wherein the anti-rotation connection mount is configured for attachment to a tag line extending from a dredging crane to restrict rotation of the clam-link and the clam shell bucket.

2. A clam-link as recited in claim 1 wherein the anti-rotation connection mount includes at least one arm (member) that extends outward from the support structure.

3. A clam-link as recited in claim 2 wherein the anti-rotation connection mount further includes a second arm disposed outward from the support structure wherein the angle between the anti-rotation arms is substantially 90 degrees.

4. A clam-link as recited in claim 1 wherein the anti-rotation connection mount includes two arms that extend outward from the support structure, wherein the angle between the anti-rotation arms is substantially 90 degrees.

5. An elongate rigid link configured to connect a suspended implement to a vertically oriented holding wire hanging from a crane and to a tag line for horizontal control to restrict the elongate rigid link from rotation, the elongate rigid link comprising:
an elongate rigid element having an upper first end configured to operably attach to the holding wire suspended from the crane and a second lower end configured to operably attach to the suspended implement; and,
at least one anti-rotation connection element located at an upper portion of the elongated rigid link and configured to operably attach to the tag line.

6. A elongate rigid link as recited in claim 5 wherein the crane is a dredging crane, the elongate rigid link is a clam-link and the suspended element is a digging device.

7. A elongate rigid link as recited in claim 6 wherein the digging device is a clam shell bucket.

8. A elongate rigid link as recited in claim 5 wherein the anti-rotation connection element comprises at least one arm extending outwardly from the elongate rigid element and configured to connect to a tagline.

9. A elongate rigid link as recited in claim 8 wherein the anti-rotation connection element further comprises a second arm extending outwardly from the elongate rigid element at substantially a 90° angle relative to the first arm.

10. A elongate rigid link as recited in claim 8 wherein the anti-rotation connection element further comprises a second arm extending outwardly from the elongate rigid element at an angle relative to the first arm, wherein a chain extends between the one arm and the second arm to provide multiple attachment points for the tagline.

11. A elongate rigid link as recited in claim 5 wherein the elongate rigid link further comprises at least one rotationally adjustable element controlling an angle of the clam-link relative to the anti-rotation connection element and to thereby variably set an angle of the digging device relative to the crane.

12. A elongate rigid link as recited in any claim 5 wherein the elongate rigid link further comprises at least one set of calibrated marks disposed along a length of the elongate rigid link wherein the set of calibrated marks indicates a distance from a given calibrated mark to a lower end of the elongate rigid link.

13. A elongate rigid link as recited in claim 12 wherein the set of calibrated marks is located on a movable substrate that is movable along a length of the elongate rigid link to thereby adjust a z-axis location of the set of calibrated marks relative to the elongate rigid link.

14. A elongate rigid link as recited in claim 5 wherein the elongate rigid link further comprises at least one RTK GPS unit configured to indicate the elevation of the elongate rigid link.

15. A elongate rigid link as recited in claim 5 wherein the elongate rigid link is a hollow tube.

16. A elongate rigid link as recited in claim 15 wherein the hollow tube contains at least one float within the tube, the float configured to indicate a water level within the tube and the claim link further comprises at least one measurement device located above the float configured to measure a distance from the measurement device to the float.

17. A elongate rigid link as recited in claim 5 wherein the elongate rigid link further comprises at least one target configured to reflect a beam from a remotely located tracking device.

18. A elongate rigid link as recited in claim 17 wherein the target is a prism target.

19. A elongate rigid link as recited in claim 5 wherein the elongate rigid link further comprises at least one pressure transducer configured to indicate a depth of a distal end of the elongate rigid link below a water surface.

20. A crane comprising a clam-link according to claim 5 extending from a distal end of a cable hanging from a boom of the crane.

21-22. (canceled)

23. An elongated rigid link configured to connect a suspended implement to a vertically oriented holding wire hanging from a crane, the elongated rigid link comprising:
an elongate rigid element having an upper first end configured to operably attach to the holding wire, a second lower end configured to operably attach to the suspended implement, and at least one z-axis calibration device configured to identify a z-axis elevation of the elongated rigid link and thereby the suspended element.

24-37. (canceled)

38. A method of operating a dredging crane comprising:
a) providing a crane comprising a hanging wire having a clam-link according to claim 1; and,
b) raising or lowering a clam-shell bucket suspended from a lower end of the clam-link.

39-41. (canceled)

42. A method of operating a crane comprising:
a) providing a crane comprising a hanging wire having an elongate rigid link according to claim 5; and,
b) raising or lowering a suspended implement suspended from a distal end of the elongate rigid link.

43-56. (canceled)

57. A method of using an elongate rigid link comprising:
a) providing an elongate rigid link according to claim 5; and,
b) connecting a distal end of the elongate rigid link to suspend a suspended implement from the elongate rigid link.

58-73. (canceled)

74. A method of determining a z-axis elevation of an elongate rigid link comprising:
a) providing the elongate rigid link according to claim 23; and,
b) reading the z-axis elevation of the at least one z-axis calibration device of the elongated rigid link and thereby determining the z-axis elevation of the elongate rigid link.

75-91. (canceled)

92. An assembly comprising:
a crane;
a vertically oriented holding wire hanging from the crane;
a suspended implement hanging from the holding wire; and
an elongated rigid link disposed between a distal end of the holding wire and a proximal end of the suspended implement, the elongated rigid link comprising an elongate rigid element having an upper first end configured to operably attach to the holding wire and a second lower end configured to operably attach to the suspended implement.

93-109. (canceled)
